(19) United States
(12) Patent Application Publication
(10) Pub. No.: US 2026/0359958 A1
(43) Pub. Date: Nov. 12, 2026

(54) DIFFUSION BASED SUPER RESOLUTION WITH PERCEPTUAL LOSS

(71) Applicant: Samsung Electronics Co., Ltd., Suwon-si (KR)

(72) Inventors: Joonsoo Kim, Irvine, CA (US); Tien C. Bau, Irvine, CA (US)

(21) Appl. No.: 19/646,185

(22) Filed: Apr. 13, 2026

Related U.S. Application Data
(60) Provisional application No. 63/802,452, filed on May 8, 2025.

(51) Int. Cl. G06T 5/92; G06T 5/60; G06T 5/70

(52) U.S. Cl. CPC G06T 5/92; G06T 5/60; G06T 5/70; G06T 2207/20076; G06T 2207/20081; G06T 2207/20084

(57) ABSTRACT

A method includes generating a super resolution (SR) image using an artificial intelligence model to restore perceptual details of an image. The artificial intelligence model is trained using perceptual loss, and the perceptual loss is calculated using a predicted denoised residual image, an original denoised residual image, and a low-resolution (LR) image. The method further includes outputting the generated SR image.

### CROSS-REFERENCE TO RELATED APPLICATION AND PRIORITY CLAIM

This application claims priority under 35 U.S.C. § 119(e) to U.S. Provisional Patent Application No. 63/802,452 filed on May 8, 2025, which is hereby incorporated by reference in its entirety.

### TECHNICAL FIELD

This disclosure relates generally to artificial intelligence (AI) and image processing systems. More specifically, this disclosure relates to diffusion based super resolution with perceptual loss.

### BACKGROUND

Since stable diffusion emerged, diffusion has been used in image generative AI applications such as image generation, image super resolution, image in-painting, image out-painting, etc. Even for super resolution (SR) image generation where generative adversarial network (GAN)-based methods have been adopted, other diffusion-based methods have been proposed recently that exhibit better results than GAN-based SR methods. Besides the results, there is a significant advantage of diffusion-based SR methods over GAN-based SR methods, because diffusion-based SR methods can train the network more stably. In GAN-based SR methods, a generator and a discriminator compete each other during training to create details, and it often causes a “mode collapse” issue. Since diffusion-based SR methods do not require any discriminator to create the details, there is no “mode collapse” issue. However, there still exist opportunities to improve diffusion-based SR methods.

### SUMMARY

This disclosure relates to diffusion based super resolution with perceptual loss.

In one embodiment, a method includes generating a super resolution (SR) image using an artificial intelligence model to restore perceptual details of an image. The artificial intelligence model is trained using perceptual loss, and the perceptual loss is calculated using a predicted denoised residual image, an original denoised residual image, and a low-resolution (LR) image. The method further includes outputting the generated SR image.

In another embodiment, an electronic device includes at least one processing device. The at least one processing device is configured to generate a super resolution (SR) image using an artificial intelligence model to restore perceptual details of an image, The artificial intelligence model is trained using perceptual loss, and wherein the perceptual loss is calculated using a predicted denoised residual image, an original denoised residual image, and a low-resolution (LR) image. The at least one processing device is also configured to output the generated SR image.

A non-transitory machine-readable medium containing instructions that when executed cause at least one processor of an electronic device to generate a super resolution (SR) image using an artificial intelligence model to restore perceptual details of an image, wherein the artificial intelligence model is trained using perceptual loss, and wherein the perceptual loss is calculated using a predicted denoised residual image, an original denoised residual image, and a low-resolution (LR) image, and output the generated SR image.

Any single one or any combination of the following features may be used with the above embodiments. A loss function for the perceptual loss can assign different weights to noise loss and the perceptual loss at different time steps. A noisy image feature map can be generated using a perceptual network for use in generating the SR image. The artificial intelligence model can be a denoising network, and the predicted denoised residual image can be generated using the LR image and a predicted noise map provided by the denoising network from a noisy residual input image. The original denoised residual image can be generated using an original noise map associated with the noisy residual input image. To calculate the perceptual loss, a predicted SR image can be reconstructed by combining the predicted denoised residual image with the LR image, an original SR image can be reconstructed by combining the original denoised residual image with the LR image, and the reconstructed predicted SR image and the reconstructed original SR image can be provided to the perceptual network to determine the perceptual loss. The artificial intelligence model can be trained using both the perceptual loss and an L1 distance between the original noise map and the predicted noise map.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration including an electronic device in accordance with this disclosure;

FIG. 2 illustrates an example diffusion-based super resolution system with perceptual loss in accordance with this disclosure;

FIG. 3 illustrates a diffusion-based super resolution generation process in accordance with this disclosure;

FIG. 4 illustrates a diffusion-based super resolution perceptual loss training process in accordance with this disclosure;

FIGS. 5A through 5C illustrate an example set of images showing how a denoising network trained with perceptual loss improves image quality;

FIGS. 6A through 6C illustrate another example set of images showing how a denoising network trained with perceptual loss improves image quality;

FIG. 7 illustrates an example method for generating a super resolution image in accordance with this disclosure; and

FIG. 8 illustrates an example method for diffusion-based super resolution training with perceptual loss in accordance with this disclosure.

### DETAILED DESCRIPTION

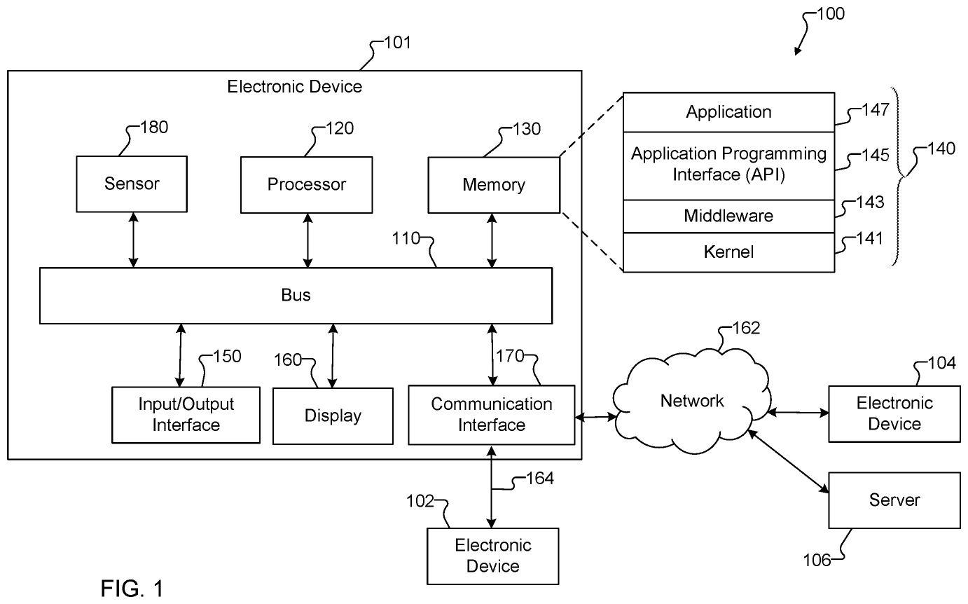

FIGS. 1 through 8, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, since stable diffusion emerged, diffusion has been used in image generative AI applications such as image generation, image super resolution, image in-painting, image out-painting, etc. Even for super resolution (SR) image generation where generative adversarial network (GAN)-based methods have been adopted, other diffusion-based methods have been proposed recently that exhibit better results than GAN-based SR methods. Besides the results, there is a significant advantage of diffusion-based SR methods over GAN-based SR methods, because diffusion-based SR methods can train the network more stably. In GAN-based SR methods, a generator and a discriminator compete each other during training to create details, and it often causes a “mode collapse” issue. Since diffusion-based SR methods do not require any discriminator to create the details, there is no “mode collapse” issue. However, there still exist opportunities to improve diffusion-based SR methods.

The various embodiments of this disclosure provide for diffusion-based super resolution with perceptual loss. This disclosure incorporates perceptual loss into diffusion-based SR to enhance the details of generated SR images, which is not found in prior diffusion-based SR approaches. Existing pre-trained classification/segmentation networks, which are used to calculate perceptual loss, do not work for a very noisy image, and thus previous in diffusion-based SR approaches. Attempts to incorporate perceptual loss in diffusion-based SR required separately training a classification/segmentation network on very noisy images, which is very difficult and time-consuming.

Previous approaches have also used a latent diffusion model (LDM) to compute perceptual loss. However, there are many limitations in using an LDM in general diffusion based SR. First, the LDM model large and so it requires very large GPU memory to load. Also, the LDM is an image generation model using text prompts, and so the LDM cannot be directly used for SR purposes.

There thus exist at least two reasons that perceptual loss has not been effectively applied into the diffusion-based SR directly. First, existing g pre-trained classification/segmentation networks cannot be used for perceptual loss because, previously, pre-trained classification/segmentation networks have been used to compute the perceptual loss in many SR applications because they have object recognition built-in. However, they cannot be used in diffusion based SR directly because they are not trained on very noisy images. When the reverse process is performed in diffusion, the noisy image in the large time step is very noisy, and the pre-trained classification/segmentation network cannot generate meaningful feature map on these noisy images. Also, the denoising network in diffusion-based SR predicts not the SR output but the noise component of a noisy image. However, the classification/segmentation requires the entire image for calculating perceptual loss. This disclosure thus provides for converting the predicted noise to a predicted SR during training.

Second, training of diffusion-based SR would not converge. That is, when the predicted SR is generated from the predicted noise in the beginning of training, the inaccurately estimated noise would generate a very inaccurate SR, which causes the training to diverge.

Embodiments of this disclosure, among other things, provide for using perceptual loss in diffusion-based super resolution (SR) to restore perceptual detail, provide a loss function that assigns different weights to noise loss and perceptual loss at different time steps, and provide a residual approach for computing perceptual loss in diffusion-based super resolution to mitigate the divergence of the training, the residual approach being configured to incorporate a low-resolution (LR) component in a predicted SR image.

Note that while some of the embodiments discussed below are described in the context of use in consumer electronic devices (such as smartphones), this is merely one example. It will be understood that the principles of this disclosure may be implemented in any number of other suitable contexts and may use any suitable device or devices. Also note that while some of the embodiments discussed below are described based on the assumption that one device (such as a server) performs training of a machine learning model that is deployed to one or more other devices (such as one or more consumer electronic devices), this is also merely one example. It will be understood that the principles of this disclosure may be implemented using any number of devices, including a single device that both trains and uses a machine learning model. In general, this disclosure is not limited to use with any specific type(s) of device(s).

The diffusion-based SR with perceptual loss of this disclosure can be used in a variety of application. For example, it could be used in SR-based image/video up-scaling for devices such as television devices. Generally, diffusion based SR uses a large network size and large time steps for inferencing. However, if the network size and total number of time steps are reduced, the details of SR would be significantly reduced. Therefore, training a smaller network and with less time steps with perceptual loss become significantly helpful.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described in more detail below, the processor 120 may perform various operations related to diffusion based super resolution with perceptual loss.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support various functions related to diffusion based super resolution with perceptual loss. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as an HMD). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, that include one or more imaging sensors.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described in more detail below, the server 106 may perform various operations related to diffusion based super resolution with perceptual loss.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

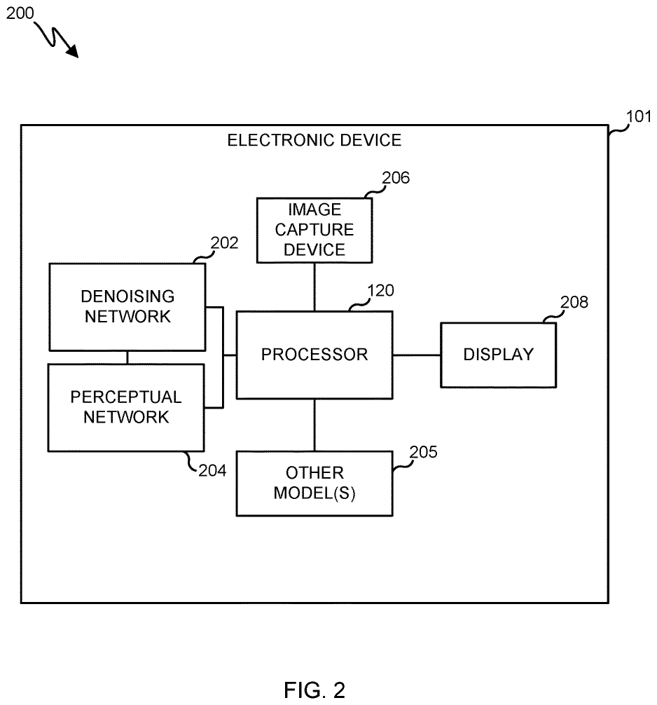

FIG. 2 illustrates an example diffusion-based super resolution system 200 with perceptual loss in accordance with this disclosure. For ease of explanation, the system 200 is described as involving the use of the electronic device 101 in the network configuration 100 of FIG. 1. However, the system 200 may be used with any other suitable electronic device(s), such as the server 106, and in any other suitable system(s).

As shown in FIG. 2, the system 200 includes the electronic device 101, which includes the processor 120. The processor 120 is operatively coupled to or otherwise configured to use one or more machine learning models, such as a denoising network 202 and a perceptual network 204. The denoising network 202 can be trained to generate SR images by predicting noise from noisy residual images that is then combined with a low-resolution (LR) image to generate a reconstructed SR image, as further described in the various embodiments of this disclosure. The perceptual network 204 can take the reconstructed SR image and a reconstructed high-quality (HR) image created from original image noise to generate a noisy image feature map for use in generating the final SR image. In various embodiments, during training, a perceptual loss is calculated for use in training the denoising network 202 that takes into account the output of the perceptual network 204, the original noise, and the predicted noise provided by the denoising network.

The processor 120 can also be operatively coupled to or otherwise configured to use one or more other models 205, such as one or more automated speech recognition (ASR) models, one or more nature language understanding (NLU) models, one or more large language models (LLMs), etc. It will be understood that the machine learning models 202, 204, 205 can be stored in a memory of the electronic device 101 (such as the memory 130) and accessed by the processor 120 to perform their respective tasks. However, the machine learning models 202, 204, 205 can be stored in any other suitable manner.

The system 200 also includes an image capture device 206 (such as a camera) and a display 208 (such as a screen or a monitor like the display 160). The processor 120 can receive input images captured or otherwise obtained by the image capture device 206 and use the denoising network 202 and the perceptual network 204 to generate an SR image based on the obtained image. However, it will be understood that input images may be obtained in other ways, such as retrieving a stored image from a memory of the electronic device 101. The generated SR image may be displayed on the display 208.

Although FIG. 2 illustrates one example of a diffusion-based super resolution system 200, various changes may be made to FIG. 2. For example, the image capture device 206 and the display 208 can be connected to the processor 120 within the electronic device 101, such as via wired connections or circuitry. In other embodiments, the image capture device 206 and the display 208 can be external to the electronic device 101 and connected via wired or wireless connections. Also, in some cases, denoising network 202, the perceptual network 204, and/or the one or more of the other machine learning models 205, can be stored as separate models called upon by the processor 120 to perform certain tasks or can be included in and form a part of one or more larger machine learning models. Further, in some embodiments, one or more of the machine learning models, including denoising network 202, the perceptual network 204, and/or the one or more of the other machine learning models 205, can be stored remotely from the electronic device 101, such as on the server 106. Here, the electronic device 101 can transmit requests including inputs (such as image data) to the server 106 for processing of the inputs using the machine learning models, and the results can be sent back to the electronic device 101. In addition, in some embodiments, the electronic device 101 can be replaced by the server 106, which receives image data from a client device for processing and transmits information back to the client device, such as generated SR images.

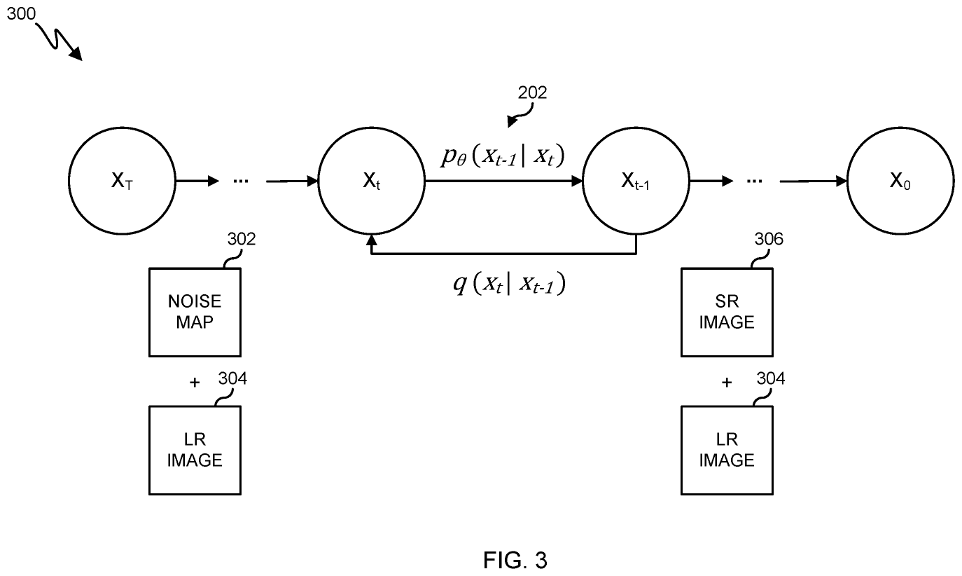

FIG. 3 illustrates a diffusion-based SR generation process 300 in accordance with this disclosure. For ease of explanation, the process 300 shown in FIG. 3 is described as being implemented on or supported by the electronic device 101 in the network configuration 100 of FIG. 1. However, the process 300 shown in FIG. 3 could be used with any other suitable device(s) and in any other suitable system(s), such as when the process 300 is implemented on or supported by the server 106.

As shown in FIG. 3, the diffusion-based SR generation process converts noise into image details. To do this, a randomly generated noise map 302 and a low-resolution (LR) image 304 (low resolution) image are inserted into the denoising network 202, which progressively converts the noise map 302 to a SR image 306. More specifically, the denoising network 202 predicts the noise map 302 only from a noisy image at time t, where the noisy image is assumed to be an SR image plus noise. Then, the SR image 306 is generated by removing the predicted noise from the noisy image. Since this process is iteratively done through multiple time steps (e.g., from t=T to t=0 as shown in FIG. 3), the noisy image would be progressively converted into the SR image. This can be referred to as a “reverse process” for diffusion.

Although FIG. 3 illustrates one example of a diffusion-based SR generation process 300, various changes may be made to FIG. 3. For example, various components and functions in FIG. 3 may be combined, further subdivided, replicated, or rearranged according to particular needs. Also, one or more additional components and functions may be included if needed or desired.

Embodiments of this disclosure, among other things, provide for using perceptual loss in diffusion-based super resolution (SR) to restore perceptual detail, provide a loss function that assigns different weights to noise loss and perceptual loss at different time steps, and provide a residual approach for computing perceptual loss in diffusion-based super resolution to mitigate the divergence of the training, the residual approach being configured to incorporate a low-resolution (LR) component in a predicted SR image.

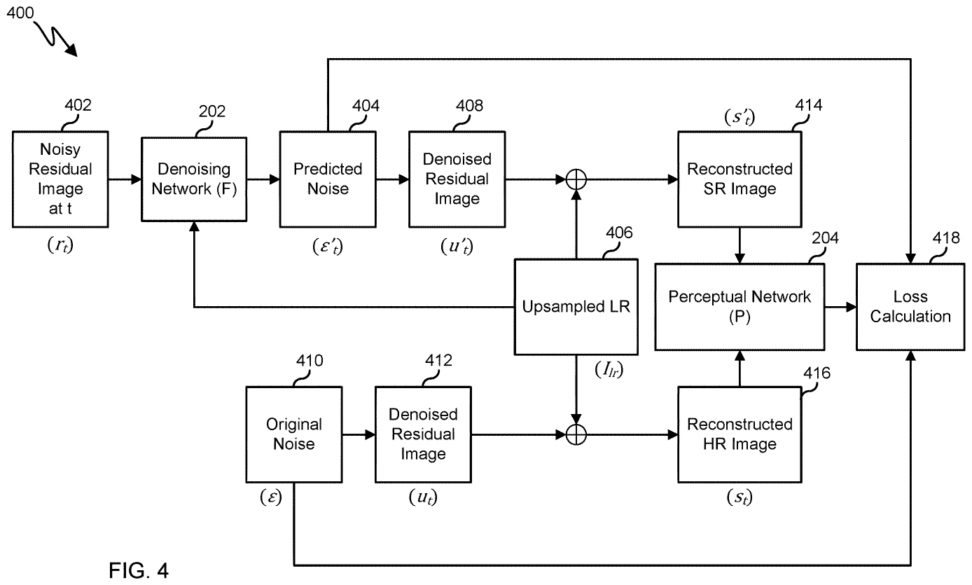

FIG. 4 illustrates a diffusion-based SR perceptual loss training process 400 in accordance with this disclosure. For ease of explanation, the process 400 shown in FIG. 4 is described as being implemented on or supported by the electronic device 101 in the network configuration 100 of FIG. 1. However, the process 400 shown in FIG. 4 could be used with any other suitable device(s) and in any other suitable system(s), such as when the process 400 is implemented on or supported by the server 106.

As shown in FIG. 4, the process 400 uses a residual approach for computing perceptual loss in diffusion-based SR. As shown in FIG. 4, reconstructed SR images created from predicted noise always include an LR component at any time step t and any epoch, which assists in causing the denoising network 202 to converge well.

Specifically, as shown in FIG. 4, a noisy residual image 402 (rₜ) is generated at a time step t. Generation of the noisy residual image 402 can be expressed as follows.

$${r}_{t} = \sqrt{\overline{{α}_{t}}} \cdot r + \sqrt{1 - \overline{{α}_{t}}} \cdot {ε}_{t} where {ε}_{t} \sim N ( 0 , 1 )$$

Then, the denoising network 202 (F) provides predicted noise 404

$$( {ε}_{t}^{′} ) ,$$

given the noisy residual image 402 (rₜ), an upsampled LR image 406 (Iₗᵣ), and time step t, which can be expressed as follows.

$${ε}_{t}^{′} = F ( {r}_{t} , {I}_{lr} , t )$$

Using the predicted noise 404

$$( {ε}_{t}^{′} )$$

at time step t, a denoised residual image 408

$$( {u}_{t}^{′} )$$

at time step t is predicted, which can be represented as follows.

$${u}_{t}^{′} = \frac{\sqrt{\overline{{α}_{t - 1}}} \cdot ( 1 - {α}_{t} )}{1 - \overline{{α}_{t}}} {r}_{0}^{′} + \frac{\sqrt{\overline{{α}_{t}}} \cdot ( 1 - \overline{{α}_{t - 1}} )}{1 - \overline{{α}_{t}}} {r}_{t}$$

Here,

$${r}_{0}^{′} = \frac{1}{\sqrt{\overline{{α}_{t}}}} {r}_{t} - ( \sqrt{\frac{1}{\overline{{α}_{t}}} - 1} ) {ε}_{t}^{′} .$$

Similarly, using original noise 410 (ε), a denoised residual image 412 (uₜ) is predicted at time step t, which can be expressed as follows.

$${u}_{t} = \frac{\sqrt{\overline{{α}_{t - 1}}} \cdot ( 1 - {α}_{t} )}{1 - \overline{{α}_{t}}} r + \frac{\sqrt{\overline{{α}_{t}}} \cdot ( 1 - \overline{{α}_{t - 1}} )}{1 - \overline{{α}_{t}}} {r}_{t}$$

Using a combination of the upsampled LR image 406 (Iₗᵣ) and the denoised residual image 408

$$( {u}_{t}^{′} )$$

generated using the predicted noise 404

$$( {ε}_{t}^{′} ) ,$$

a reconstructed predicted SR image 414 at time step t is created, which can be expressed as follows.

$${s}_{t}^{′} = {u}_{t}^{′} + {I}_{lr}$$

Likewise, using a combination of the upsampled LR image 406 (Iₗᵣ) and the denoised residual image 412 (uₜ) generated using the original noise 410 (ε), a reconstructed high resolution (HR) image 416 corresponding to the original SR image is created at time step t, which can be expressed as follows.

sₜ=uₜ+Iₗᵣ

As shown in FIG. 4, the reconstructed SR image 414 and the reconstructed HR image 416 are provided to the perceptual network 204 to provide a perceptual loss via a loss calculation operation 418 for use in training the denoising network 202.

Generally, for diffusion-based SR, the denoising network 202 is trained using the noisy HR image at a certain time step (t) and the corresponding LR image as inputs and the noise component only is predicted from the noisy HR image. Once the denoising network 202 is trained so that it can predict the noise at any time step, the SR image can be generated from complete noise input by recursively repeating the denoising process during inferencing.

Thus, as part of training the denoising network 202, pairs including a high resolution image (Iₗᵣ) and a low resolution image (Iₗᵣ) are prepared first. Generating the noisy HR image is done by a weighted sum of HR image and a noise. Note that the degree of noise, which is added to HR image for the noisy HR image, can be determined by a noise scheduler, which is controlled by αₜ. Then, the denoising network 202 is trained to predict the original noise, which is randomly generated during training, from the noisy HR image. For the loss function, L1 loss between the original noise and the predicted noise can be used in various embodiments. In the process 400, the residual (r=Iₕᵣ−Iₗᵣ) is enhanced rather than restoring the entire HR image. Therefore, the noisy residual image 402 (r^{t}) is generated rather than a noisy HR image. The noisy residual image 402 r^{t} is generated by a noise scheduler like that shown below.

$${r}_{t} = \sqrt{\overline{{α}_{t}}} \cdot r + \sqrt{1 - \overline{{α}_{t}}} \cdot {ε}_{t}$$

Here,

$$\overline{{α}_{t}} = {\prod }_{i = 1}^{t}$$

αₜ and εₜ is a randomly generated Gaussian noise map at t (N(0,1)).

Since both the noisy residual image 402 at t (rₜ) and the corresponding noise (εₜ) are obtained, the denoising network 202 (F) can be initially trained by minimizing the L1 distance between the original noise map (ε) and the predicted noise map

$$( {ε}_{t}^{′} = F ( {r}_{t} , {I}_{lr} , t ) ) ,$$

which can be expressed as follows.

$${argmin}_{F} \vert {ε}_{t} - {ε}_{t}^{′} \vert = {argmin}_{F} \vert {ε}_{t} - F ( {r}_{t} , {I}_{lr} , t ) \vert$$

To increase the level of detail in the SR image, perceptual loss is used in addition to the above L1 loss. To calculate the perceptual loss via the loss calculation operation 418, the denoised SR image 414 is restored from the predicted noise 404 at time step t first. It should be noted that, in various embodiments, denoising diffusion probabilistic models (DDPM) may be used for inferencing, and so the denoised SR image is still noisy because the amount of noise between time step t and time step t−1 may only be denoised in DDPM inferencing. Then, the perceptual loss network, which can be a VISUAL GEOMETRY GROUP (VGG) network in some embodiments, can be used for performing perceptual loss calculation operation 418, to compute the perceptual loss between the reconstructed SR image 414 and the reconstructed HR image 416 at time step t.

The loss calculation operation 418 uses a unique loss function that assigns different weights to the noise loss and the perceptual loss at different time steps. That is, in different time steps, different weights are applied between the noise loss and the perceptual loss. In various embodiments, more weight is assigned to noise loss at larger time steps and less weight is assigned to noise loss at smaller time steps. In various embodiments, it is beneficial to use a pre-trained classification/segmentation network, which is not trained on very noisy images for computing perceptual loss, because the perceptual loss is considered less on very noisy images, and because it helps the training converge stably. The loss function that includes noise loss and perceptual loss with weights can thus be represented as follows.

$$loss = {w}_{1} \vert {ε}_{t} - {ε}_{t}^{′} \vert + {w}_{2} {\sum }_{l} \vert {P}_{l} ( {s}_{t} ) - {P}_{l} ( {s}_{t}^{′} ) \vert$$

Here, P is the perceptual network and Pₗ( ) can generate a feature map at the l^{th} layer. In various embodiments,

$${w}_{1} = \sqrt{\frac{1}{\overline{{α}_{t}}} - 1}$$

and w₂=constant.

As shown above, the perceptual loss function creates a different ratio between noise loss and perceptual loss in different time steps. Since α̅ₜ̅ becomes smaller as t increases, noise loss is mainly used for very noisy image inputs (t: large). This helps in allowing use of an existing pre-trained classification/segmentation network in a stable manner.

This residual approach for computing perceptual loss in diffusion-based SR helps to avoid divergence of training, and guarantees that the predicted SR always includes LR components, so the situation of the training diverging due to inaccurately predicted noise generating an inaccurate SR image can be avoided. That is, if the denoising network is trained without the residual approach, the training would not converge correctly because the LR part of the predicted SR could be very different from the LR part of the original SR.

Although FIG. 4 illustrates one example of diffusion-based SR perceptual loss training process 400, various changes may be made to FIG. 4. For example, various components and functions in FIG. 4 may be combined, further subdivided, replicated, or rearranged according to particular needs. Also, one or more additional components and functions may be included if needed or desired.

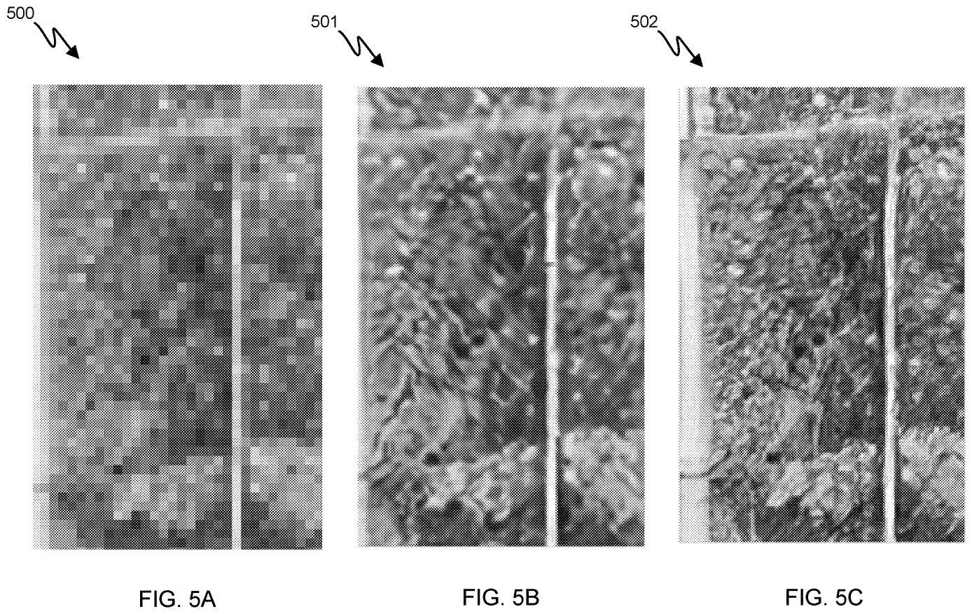

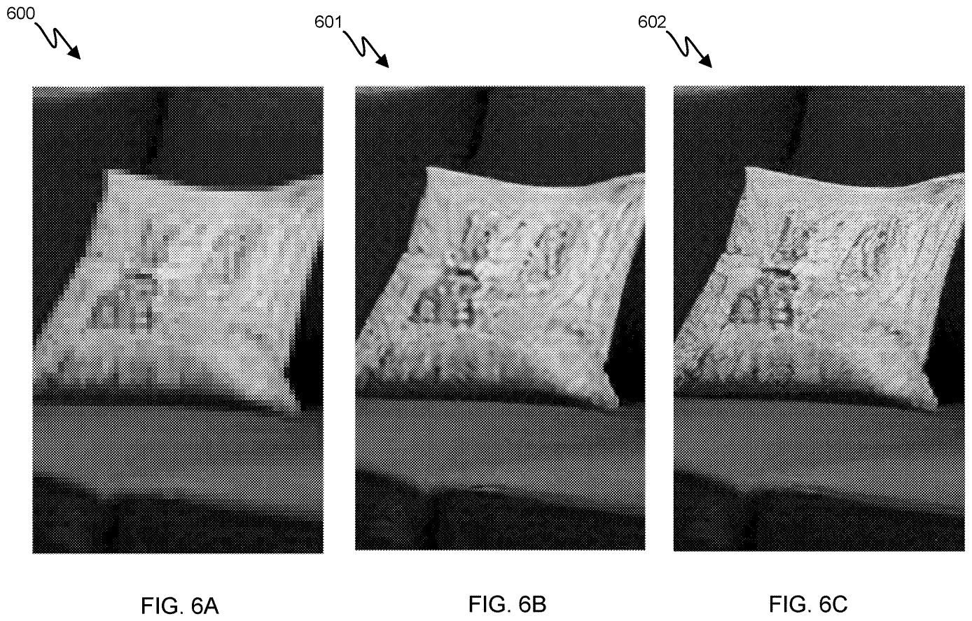

The denoising network 202 trained using perceptual loss as detailed above provides noticeable benefits in image quality. For example, FIGS. 5A through 5C illustrate an example set of images showing how the denoising network 202 trained with perceptual loss improves image quality and FIGS. 6A through 6C illustrate another example set of images showing how the denoising network 202 trained with perceptual loss improves image quality.

The example set of images of FIGS. 5A though 5C includes various images of a plant. FIG. 5A shows an example LR image 500 of the plant, FIG. 5B shows an example SR image 501 of the plant generated without perceptual loss, and FIG. 5C shows an example SR image 502 of the plant generated using perceptual loss as described in this disclosure.

As demonstrated in FIGS. 5A through 5C, diffusion-based SR results are improved through perceptual loss. Although the SR image 501 of FIG. 5B created without perceptual loss provides an image quality improvement over the LR image 500 of FIG. 5A, the SR image 502 of FIG. 5C created using perceptual loss provides for even further enhanced details (e.g., sharper and cleaner details) over the SR image 501 created without using perceptual loss. This is because, while previous diffusion methods may train the denoiser network by minimizing the noise loss (the difference between original noise and predicted noise) at different time steps, the perceptual loss method of this disclosure minimizes a loss that combines the noise loss and the perceptual loss at different time steps.

Similarly, the example set of images of FIGS. 6A though 6C includes various images of a scene including a pillow placed on a couch. FIG. 6A shows an example LR image 600 of the scene, FIG. 6B shows an example SR image 601 of the scene generated without perceptual loss, and FIG. 6C shows an example SR image 602 of the scene generated using perceptual loss as described in this disclosure.

As demonstrated in FIGS. 6A through 6C, diffusion-based SR results are improved through perceptual loss. Although the SR image 601 of FIG. 6B created without perceptual loss provides an image quality improvement over the LR image 600 of FIG. 6A, the SR image 602 of FIG. 6C created using perceptual loss provides for even further enhanced details (e.g., sharper and cleaner details) over the SR image 601 created without using perceptual loss.

Although FIGS. 5A-6C illustrate example comparisons of LR images, SR images created without perceptual loss, and SR images creates with perceptual loss, various changes may be made to FIGS. 5A-6C. For example, the image content shown in FIGS. 5A-6C are merely examples, and the images could be of any possible subject matter.

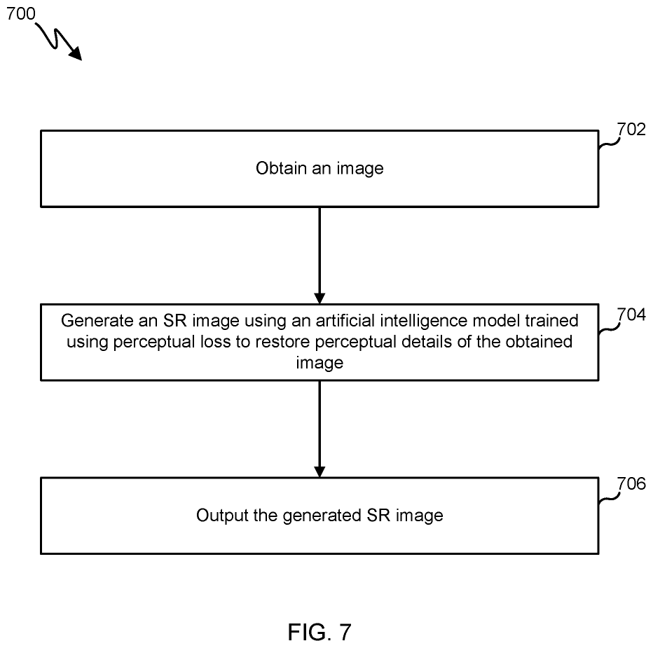

FIG. 7 illustrates an example method 700 for generating an SR image in accordance with this disclosure. For ease of explanation, the method 700 shown in FIG. 7 is described as being performed using the electronic device 101 in the network configuration 100 of FIG. 1. However, the method 700 could be performed using any other suitable device(s), such as the server 106, and in any other suitable system(s).

At step 702, the electronic device 101 obtains an image, such as via the image capture device 206 or via other means. At step 704, an SR image is generated using an artificial intelligence model, such as the denoising network 202, trained using perceptual loss to restore perceptual details of the obtained image. The SR image can be generated using the processes 300 and 400 described in this disclosure to reconstruct SR images at various time steps using residual noise and an LR image. In various embodiments as described in this disclosure, a noisy image feature map (e.g., noise map 302) is generated using a perceptual network for use in generating the SR image. At step 706, the generated SR image is output, such as on the display 208 or sending the SR image to a digital storage location.

Although FIG. 7 illustrates one example of a method 700 for generating an SR image, various changes may be made to FIG. 7. For example, while shown as a series of steps, various steps in FIG. 7 could overlap, occur in parallel, occur in a different order, or occur any number of times (including zero times).

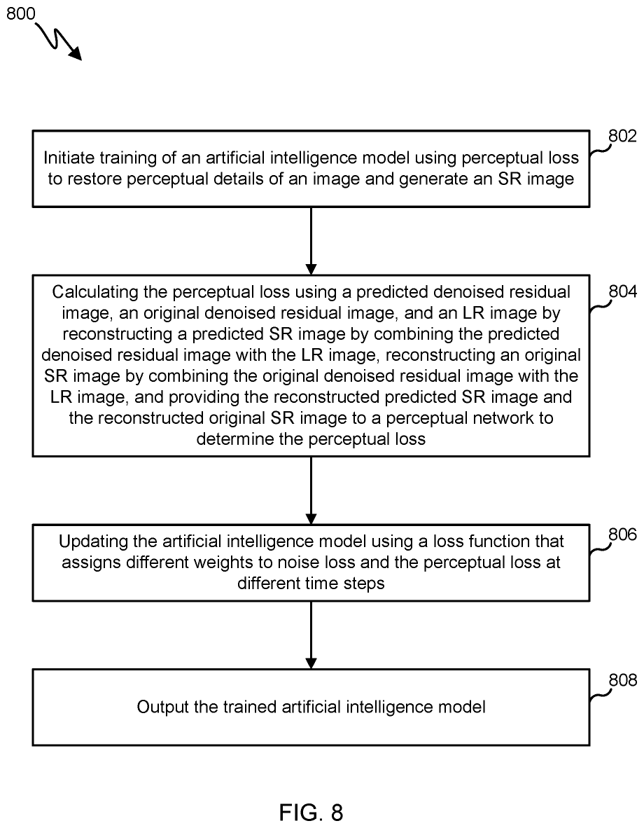

FIG. 8 illustrates an example method 800 for diffusion-based SR training with perceptual loss in accordance with this disclosure. For ease of explanation, the method 800 shown in FIG. 8 is described as being performed using the electronic device 101 in the network configuration 100 of FIG. 1. However, the method 800 could be performed using any other suitable device(s), such as the server 106, and in any other suitable system(s).

At step 802, training of an artificial intelligence model (e.g., the denoising network 202) using perceptual loss to restore perceptual details on an image and generate an SR image is initiated. At step 804, the perceptual loss is calculated using a predicted denoised residual image (e.g., denoised residual image 408), an original denoised residual image (e.g. denoised residual image 412), and an LR image (e.g., upsampled LR image 406) by reconstructing a predicted SR image (e.g., reconstructed SR image 414) by combining the predicted denoised residual image with the LR image, reconstructing an original SR image (e.g., reconstructed HR image 416) by combining the original denoised residual image with the LR image, and providing the reconstructed predicted SR image and the reconstructed original SR image to a perceptual network (e.g., perceptual network 204) to determine the perceptual loss.

In various embodiments as described in this disclosure, the predicted denoised residual image is generated using the LR image and a predicted noise map (e.g., predicted noise 404) provided by the denoising network from a noisy residual input image (e.g., noisy residual image 402). In various embodiments as described in this disclosure, the original denoised residual image is generated using an original noise map (e.g., original noise 410) associated with the noisy residual input image.

At step 806, the artificial intelligence model is updated using a loss function that assigns different weights to noise loss and the perceptual loss at different time steps, such as that described with respect to the loss calculation operation 418 of this disclosure. In various embodiments as described in this disclosure, the artificial intelligence model can be trained using both the perceptual loss and an L1 distance between the original noise map and the predicted noise map. At step 808, the trained artificial intelligence model is output for use during inferencing.

Although FIG. 8 illustrates one example of a method 800 for diffusion-based SR training with perceptual loss, various changes may be made to FIG. 8. For example, while shown as a series of steps, various steps in FIG. 8 could overlap, occur in parallel, occur in a different order, or occur any number of times (including zero times).

It should be noted that the functions shown in or described with respect to the figures can be implemented in an electronic device 101, 102, 104, server 106, or other device(s) in any suitable manner. For example, in some embodiments, at least some of the functions shown in or described with respect to the figures can be implemented or supported using one or more software applications or other software instructions that are executed by the processor 120 of the electronic device 101, 102, 104, server 106, or other device(s). In other embodiments, at least some of the functions shown in or described with respect to the figures can be implemented or supported using dedicated hardware components. In general, the functions shown in or described with respect to the figures can be performed using any suitable hardware or any suitable combination of hardware and software/firmware instructions. Also, the functions shown in or described with respect to the figures can be performed by a single device or by multiple devices.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
generating a super resolution (SR) image using an artificial intelligence model to restore perceptual details of an image,
wherein the artificial intelligence model is trained using perceptual loss, and
wherein the perceptual loss is calculated using a predicted denoised residual image, an original denoised residual image, and a low-resolution (LR) image; and
outputting the generated SR image.

2. The method of claim 1, wherein a loss function for the perceptual loss assigns different weights to noise loss and the perceptual loss at different time steps.

3. The method of claim 1, further comprising generating a noisy image feature map using a perceptual network for use in generating the SR image.

4. The method of claim 3, wherein the artificial intelligence model is a denoising network, and wherein the predicted denoised residual image is generated using the LR image and a predicted noise map provided by the denoising network from a noisy residual input image.

5. The method of claim 4, wherein the original denoised residual image is generated using an original noise map associated with the noisy residual input image.

6. The method of claim 5, wherein calculating the perceptual loss includes:
reconstructing a predicted SR image by combining the predicted denoised residual image with the LR image;
reconstructing an original SR image by combining the original denoised residual image with the LR image; and
providing the reconstructed predicted SR image and the reconstructed original SR image to the perceptual network to determine the perceptual loss.

7. The method of claim 5, wherein the artificial intelligence model is trained using both the perceptual loss and an L1 distance between the original noise map and the predicted noise map.

8. An electronic device comprising:
at least one processing device configured to:
generate a super resolution (SR) image using an artificial intelligence model to restore perceptual details of an image,
wherein the artificial intelligence model is trained using perceptual loss, and
wherein the perceptual loss is calculated using a predicted denoised residual image, an original denoised residual image, and a low-resolution (LR) image; and
output the generated SR image.

9. The electronic device of claim 8, wherein a loss function for the perceptual loss assigns different weights to noise loss and the perceptual loss at different time steps.

10. The electronic device of claim 8, wherein the at least one processing device is further configured to generate a noisy image feature map using a perceptual network for use in generating the SR image.

11. The electronic device of claim 10, wherein the artificial intelligence model is a denoising network, and wherein the predicted denoised residual image is generated using the LR image and a predicted noise map provided by the denoising network from a noisy residual input image.

12. The electronic device of claim 11, wherein the original denoised residual image is generated using an original noise map associated with the noisy residual input image.

13. The electronic device of claim 12, wherein, to calculate the perceptual loss:
a predicted SR image is reconstructed by combining the predicted denoised residual image with the LR image;
an original SR image is reconstructed by combining the original denoised residual image with the LR image; and
the reconstructed predicted SR image and the reconstructed original SR image are provided to the perceptual network to determine the perceptual loss.

14. The electronic device of claim 12, wherein the artificial intelligence model is trained using both the perceptual loss and an L1 distance between the original noise map and the predicted noise map.

15. A non-transitory machine-readable medium containing instructions that when executed cause at least one processor of an electronic device to:
generate a super resolution (SR) image using an artificial intelligence model to restore perceptual details of an image,
wherein the artificial intelligence model is trained using perceptual loss, and
wherein the perceptual loss is calculated using a predicted denoised residual image, an original denoised residual image, and a low-resolution (LR) image; and
output the generated SR image.

16. The non-transitory machine-readable medium of claim 15, wherein a loss function for the perceptual loss assigns different weights to noise loss and the perceptual loss at different time steps.

17. The non-transitory machine-readable medium of claim 15, further containing instructions that when executed cause the at least one processor to generate a noisy image feature map using a perceptual network for use in generating the SR image.

18. The non-transitory machine-readable medium of claim 17, wherein the artificial intelligence model is a denoising network, and wherein the predicted denoised residual image is generated using the LR image and a predicted noise map provided by the denoising network from a noisy residual input image.

19. The non-transitory machine-readable medium of claim 18, wherein the original denoised residual image is generated using an original noise map associated with the noisy residual input image.

20. The non-transitory machine-readable medium of claim 19, wherein, to calculate the perceptual loss:
a predicted SR image is reconstructed by combining the predicted denoised residual image with the LR image;
an original SR image is reconstructed by combining the original denoised residual image with the LR image; and
the reconstructed predicted SR image and the reconstructed original SR image are provided to the perceptual network to determine the perceptual loss.
